(19) United States
(12) Patent Application Publication
(10) Pub. No.: US 2020/0082499 A1
(43) Pub. Date: Mar. 12, 2020

(54) INFORMATION PROCESSING METHOD, COMPUTER-READABLE NON-TRANSITORY STORAGE MEDIUM HAVING PROGRAM STORED THEREON, AND INFORMATION PROCESSING DEVICE

(71) Applicant: Mercari, Inc., Minato-ku (JP)

(72) Inventors: Nobuo Suzuki, Tokyo (JP); Yasuyuki Matsuoka, Tokyo (JP)

(21) Appl. No.: 16/567,956

(22) Filed: Sep. 11, 2019

(30) Foreign Application Priority Data
Sep. 12, 2018 (JP) 2018-170641

(51) Int. Cl. G06T 3/20; G06K 19/06

(52) U.S. Cl. CPC G06T 3/20; G06K 19/06037

(57) ABSTRACT

To provide an information processing method capable of appropriately displaying an object, a computer-readable non-transitory storage medium having a program stored thereon, and an information processing device. An information processing method, executed by one or more processors included in an information processing device, including: specifying at least one of a first region in which an object is to be displayed and a second region in which display of the object is prohibited, the first region and the second region being included in a display region of a display device, based on a user operation; and displaying the object in the specified first region of the display device or displaying the object in a region other than the specified second region of the display device.

### BACKGROUND OF THE INVENTION

### Field of the Invention

The present disclosure relates to an information processing method, a computer-readable non-transitory storage medium having a program stored thereon, and an information processing device.

### Description of the Related Art

In a conventionally known system, a code is displayed in a display screen provided in a terminal, and the code is scanned a code reader provided in another terminal, so that various processing is executed. For example, Japanese Patent Laid-Open No. 2017-049970 discloses a system in which a QR code (registered trademark) displayed in a terminal of a user is scanned by a settlement device, so that a settlement process is executed.

However, when a part of display screen in which an object such as a code is to be displayed is broken, the object is not correctly displayed, whereby the visibility of the object is significantly reduced. For example, when the object is a code, in some cases, the contents of information contained in the code are erroneously recognized or the code cannot be scanned in the first place.

Thus, an object of the present disclosure is to provide an information processing method capable of appropriately displaying an object, a computer-readable non-transitory storage medium having a program stored thereon, and an information processing device.

### SUMMARY OF THE INVENTION

An information processing method according to one embodiment of the present disclosure is a method, executed by one or more processors included in an information processing device, including: specifying at least one of a first region in which an object is to be displayed and a second region in which display of the object is prohibited, the first region and the second region being included in a display region of a display device, based on a user operation; and displaying the object in the specified first region of the display device or displaying the object in a region other than the specified second region of the display device.

### BRIEF DESCRIPTION OF THE DRAWINGS

FIG. 1 illustrates a configuration of a communication system according to one aspect of an embodiment;

FIG. 2 illustrates an example of a hardware configuration of an information processing device according to the present disclosure;

FIGS. 3A and 3B each illustrate an overview of a method of displaying a two-dimensional code according to a first embodiment;

FIG. 4 illustrates as example of a block diagram illustrating a configuration of an information processing device according to the first embodiment;

FIG. 5 illustrates as example of a sequence of processing of a communication system 1 according to the first embodiment;

FIG. 6 illustrates an example of a region specification screen according to the first embodiment;

FIG. 7 illustrates an example of a process of specifying a first region which is performed by a terminal according to a first example of the first embodiment;

FIGS. 8A and 8B each illustrate an example of a process of specifying a display position and a display size of the two-dimensional code by a user;

FIG. 9 illustrates an example of a process of specifying a first region which is performed by a terminal according to a second example of the first embodiment;

FIGS. 10A and 10B in each illustrate a process of specifying the first region with use of a plurality of two-dimensional codes displayed in a display region;

FIG. 11 illustrates an example of a process of specifying a first region which is performed by a terminal according to a third example of the first embodiment;

FIG. 12 illustrates an example of a process of specifying a second region which is performed by a terminal according to a fourth example of the first embodiment;

FIG. 13 illustrates an example of a display process of a two-dimensional code which is performed by a terminal according to a fifth example of the first embodiment;

FIG. 14 illustrates an example of a display process of a two-dimensional code which is performed by a terminal according to a sixth example of the first embodiment; and

FIG. 15 illustrates a state in which a two-dimensional code is displayed in a predetermined position in a display region.

### DETAILED DESCRIPTION OF THE PREFERRED EMBODIMENTS

### Compliance with Laws and Regulations

When being embodied, the disclosure described in this specification will be embodied in compliance with the laws and regulations of each country where the present disclosure is embodied. The disclosure described in this specification is embodied with all changes, substitutions, variations, alterations, and modifications that can be made by a person having ordinary skill in the art, which are needed to comply with the laws and regulations of each country.

Hereinafter, embodiments for embodying an object display method according to the present disclosure will be described with reference to the drawings.

### System Configuration

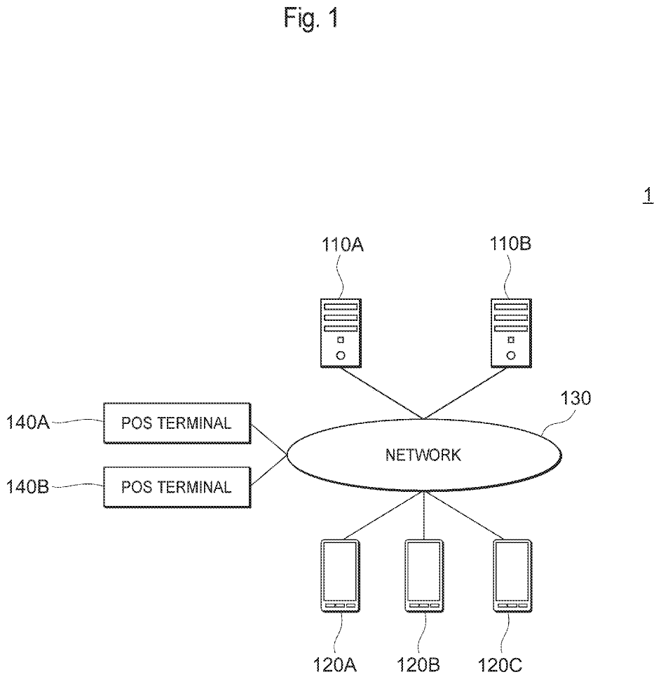

FIG. 1 illustrates a configuration of a communication system 1 according to one embodiment of the present disclosure. As disclosed, in FIG. 1, in the communication system 1, a server 110A, a server 110B, a terminal 120A, a terminal 120B, a terminal 120C, a point of sales (POS) terminal 140A, and a POS terminal 140B are connected through a network 130.

In the present disclosure, the server 110A and the server 110B may be simply referred to as a server 110 in the case where it is not necessary to individually distinguish the server 110A and the server 110B.

In the present disclosure, the terminal 120A, the terminal 120B, and the terminal 120C may be simply referred to as a terminal 120 in the case where it is not necessary to individually distinguish the terminal 120A, the terminal 120B, and the terminal 120C.

In the present disclosure, the POS terminal 140A and the POS terminal 140B may be simply referred to as a POS terminal 140 in the case where it is not necessary to individually distinguish the POS terminal 140A and the POS terminal 140B.

In the present disclosure, the server 110 and the terminal 120 may be simply referred to as an information processing device 200 in the case where it is necessary to individually distinguish the server 110 and the terminal 120. Note that the number of the information processing devices 200 to be connected to the network 130 is not limited.

The server 110 provides a predetermined service to the terminal 120 used by a user through the network 130. The predetermined service includes, for example but not limited to, a settlement service, a banking service, an electronic commerce service, a social networking service (SNS) typified by instant messenger, a content provision service such as musical composition, a moving image, and books. The user uses the predetermined service through the terminal 120, whereby the server 110 can provide the predetermined service to one or more terminals 120.

In the present disclosure, the settlement service corresponds to a service in which one or more users can give and receive money or a monetary equivalent. The settlement service includes, for example but not limited to, a service in which a settlement is executed with use of a one-dimensional code (including a bar code), a two-dimensional code (including a QR code), or near field radio communication (including NFC, BLE, Wi-Fi, and ultrasound). Furthermore, if needed, in the settlement executed with use of the one-dimensional code or the two-dimensional code, the settlement executed by causing a user who makes a payment to scan the two-dimensional code is referred to as a “user scan type QE settlement,” and the settlement executed by causing a requesting user (or a store) to scan the two-dimensional code displayed by the user who makes a payment is referred to as a “store scan type QR settlement.”

If needed, a terminal used by a user X is referred to as a terminal 120X, and user information in a predetermined service that is associated with the user X or the terminal 120X is referred to as user information X. Note that the user information is information on a user that is associated with an account used by the user in a predetermined service. The user information includes, for example but not limited to, a user name, a user icon image, an age of a user, a gender of a user, an address of a user, and interests preference of a user that are input by a user or granted by a predetermined service, information associated with a user such as a user identifier, remaining balance information of the electronic value (electronic money) associated with a user, credit card information (including a credit card number) associated with a user, or may be any one or a combination thereof.

The network 130 serves to connect two or more information processing devices 200. The network 130 corresponds to a communication network that provides a connection path that allows the terminals 120 and the servers 110 to transmit and receive data after the terminals 120 are connected to the servers 110.

One or more portions of the network 130 may be a wired network or a wireless network. The network 130 may be, for example but not limited to, an ad hoc network, an intranet, an extranet, a virtual private network (VPN), a local area network (LAN), a wireless LAN (WLAN), a wide area network (WAN), a wireless WAN (WWAN), a metropolitan area network (MAN), a part of the Internet, a part of public switched telephone network (PSTN), a mobile telephone network, integrated service digital networks (ISDNs), wireless LANs, long term evolution (LTE), code division multiple access (CDMA), Bluetooth (registered trademark), and satellite communication, or a combination of two or more of these. The network 130 may include one or more networks.

The information processing device 200 may be any information processing device as long as it is an information processing device capable of embodying the processes, functions, and/or methods described in the present disclosure.

The information processing device 200 may include, for example but not limited to, a smart phone, a mobile phone (a feature phone), a computer (such as but not limited to a desktop, a laptop, and a tablet), a server device, a media computer platform (such as but not limited to a cable set top box, a satellite set top box, and a digital video recorder), a handheld computer device (such as but not limited to a personal digital assistant (PDA), and an e-mail client), a wearable terminal (such as but not limited to a glasses-type device, and a watch-type device), any other type of a computer or a communication platform.

The POS terminal 140 is, for example, a terminal used by a store clerk or the like who receives a payment from a user who is a customer, in a store. The POS terminal 140 includes a code reader for scanning a code such as a two-dimensional code displayed in the terminal 120 of a user who is a customer. In addition, the POS terminal 140 may transmit the information on the scanned code to the server 110.

### Hardware (HW) Configuration

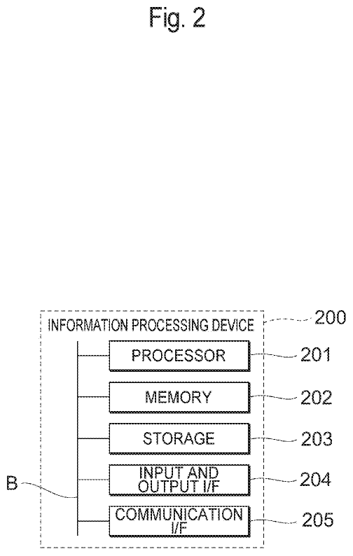

With reference to FIG. 2, the HW configuration of the information processing device 200 and the POS terminal 140 included in the communication system 1 will be described.

Each of the information processing device 200 and the POS terminal 140 includes a processor 201, a memory 202, a storage 203, an input and output interface (input and output I/F) 204, and a communication interface (communication I/F) 205. The components of the HW of the information processing device 200 and the POS terminal 140 are, for example, connected to one another via a bus B although the components are not limited to the example.

The information processing device 200 and the POS terminal 140 embody the processes, functions and/or methods described in the present disclosure in cooperation with the processor 201, the memory 202, the storage 203, the input and output I/F 204, and the communication I/F 205.

The processor 201 executes processes, functions, and/or methods embodied by codes or instructions included in the program stored in the storage 203. The processor 201 may include, for example but not limited to, one or more center processing units (CPUs), a micro processing unit (MPU), a graphics processing unit (GPU), a microprocessor, a processor core, a multiprocessor, an application-specific integrated circuit (ASIC), a field programmable gate array (FPGA), and the processor 201 may embody the processes disclosed in the embodiments by a logic circuit (hardware) provided in an integrated circuit (IC) chip and large scale integration (LSI), and a dedicated circuit. In addition, the circuits may be embodied by one or more integrated circuits, and a plurality of processes described in the embodiments may be embodied by a single integrated circuit. In addition, the LSI may also be referred to as VLSI, Super LSI, or Ultra LSI, for example, depending on the degree of integration.

The memory 202 temporarily stores programs loaded from the storage 203, and provides a working area for the processor 201. The memory 202 temporarily stores various data generated while the processor 201 executes programs. The memory 202 includes, for example but not limited to, a random access memory (RAM), and a read only memory (ROM).

The storage 203 stores programs. The storage 203 includes, for example but not limited to, a hard disk drive (HDD), a solid state drive (SSD), and a flash memory.

The communication I/F 205 transmits and receives various data through the network 130. The communication may be performed by either wired or wireless means, and any communication protocol may be used as long as mutual communication can be performed. The communication I/F 205 performs communication with another information processing device through the network 130. The communication I/F 205 transmits various data to the other information processing device according to instructions from the processor 201. Furthermore, the communication I/F 205 receives various data transmitted from the other information processing device and transmits the data to the processor 201.

The input and output I/F 204 includes an input device for inputting various operations to the information processing device 200 and the POS terminal 140, and an output device for outputting processing results processed by the information processing device 200 and the POS terminal 140. In the input and output I/F 204, the input device and the output device may be integrated, or the input device and the output device may be separated.

The input device is embodied by any one or a combination of all types of devices capable of receiving input from the user and transmitting the information on the input to the processor 201. The input device includes, for example but not limited to, hardware keys such as a touch panel, a touch display, and a keyboard, a pointing device such as a mouse, a camera (operation input through an image), and a microphone (operation input via voice). In the case of the POS terminal 140, the input device includes a reading device such as a code reader.

The output device is embodied by any one or combination of all types of devices capable of outputting the processing result processed by the processor 201. When outputting the processing result as a video image and or a moving image, the output device is embodied by any one or combination of all types of devices capable of displaying display data according to the display data written in the frame buffer. The output device includes, for example but not limited to, a touch panel, a touch display, a monitor (such as but not limited to a liquid crystal display, and an organic electroluminescence display (OELD)), a head mounted display (HMD), a projection mapping, a hologram, and a device capable of displaying images and text information, for example, in the air (that may be a vacuum), a speaker (audio output), and a printer. Note that these output devices may be capable of displaying the display data in 3D.

The program of the embodiments of the present disclosure may be provided in a state in which the program is stored in a computer-readable storage medium. The storage medium can store the program in “non-transitory tangible medium.” The program includes, for example but not limited to, a software program and a computer program.

The storage medium may include, where appropriate, one or more semiconductor-based or other integrated circuits (IC) (such as but not limited to a field programmable gate array (FPGA) and an application-specific integrated circuit (ASIC)), a hard disk drive (HDD), a hybrid hard drive (HHD), an optical disk, an optical disk drive (ODD), a magneto optical disk, a magneto optical drive, a floppy diskette, a floppy disk drive (FDD), a magnetic tape, a solid state drive (SSD), a RAM drive, a secure digital card or drive, any other suitable storage medium, or any suitable combination of two or more of them. The storage medium, where appropriate, may be volatile, non-volatile, or a combination of volatile and non-volatile.

Furthermore, the program of the present disclosure may be provided to the information. processing device 200 via any transmission medium (such as a communication network and a broadcast wave) capable of transmitting the program.

The embodiments of the present disclosure may also be embodied in the form of a data signal embedded in a carrier wave in which the program is embodied through electronic transmission.

Note that the program of the present disclosure may be installed using a script language such as JavaScript (registered trademark) and Python, C language, Go language, Swift, Kotlin, and Java (registered trademark). However, the program is not limited thereto.

At least a part of the processing in the information processing device 200 may be embodied by cloud computing configured. by one or more computers.

The system may be configured such that at least a part of the processing in the information processing device 200 is performed by another information processing device. In this case, the system may be configured such that at least a part of the processing of each unit embodied by the processor 201 is performed by the other information processing device.

### Others

Unless explicitly mentioned, the configuration of the determination in the embodiments of the present disclosure is not indispensable, and predetermined processing is performed if the determination condition is satisfied, or predetermined processing is performed if the determination condition is not satisfied.

In the present disclosure, the term “or” is used with inclusive and not exclusive meaning, unless expressly indicated otherwise or indicated otherwise by context. Therefore, in the present disclosure, the phrase “A or B” means “A, B, or both A and B” unless expressly indicated otherwise or indicated otherwise by context. Moreover, the phrase “at least one of A and B” means “only A, only B, or both A and B.” Furthermore, the article “a,” “an,” or “the” is intended to mean “one or more” unless expressly indicated otherwise or indicated otherwise by context. Therefore, in this specification, the term “an A” or “the A” means “one or more As” unless expressly indicated otherwise or indicated otherwise by context.

The disclosure encompasses all changes, substitutions, variations, alterations, and modifications that can be made by a person having ordinary skill in the art, to the embodiments and/or examples of the present disclosure. Similarly, where appropriate, the appended claims encompass all changes, substitutions, variations, alterations, and modifications that can be made by a person having ordinary skill in the art, to the embodiments and/or examples of the present disclosure. Moreover, the present, disclosure encompasses any combination of one or more features from the embodiments and/or examples in the present disclose with one or more features of other embodiments and/or examples in the present disclosure, that can be made by a person having ordinary skill in the art.

Furthermore, reference in the appended claims to a device or system or a component of a device or system being adapted to, being arranged to, having ability to, being configured to, being enabled to, being operable to, or being operative to perform a particular function encompasses that device, system, or component whether or not it or that particular function is activated, turned on, or unlocked, as long as that device, system, or component is adapted, is arranged, has ability, is configured, is enabled, is operable, or is operative in such a manner.

The present disclosure may obtain consent from the user prior to or immediately before embodying any embodiment or example unless otherwise specified. In addition, the consent to be obtained may be inclusive or may be obtained each time.

### First Embodiment

A first embodiment is an embodiment relating to an object display method of specifying at least one of a first region in which an object such as a two-dimensional code is to be displayed and a second region in which display of the object is prohibited, the first region and the second region being included in a display region of a terminal 120, based on a user operation, and displaying the object in the first region or a region other than the second region.

Although in the present embodiment an example will be described in which an object is a two-dimensional rode 125 (QR code) unless otherwise specified, the object may be, for example but not limited to, a one-dimensional code, a two-dimensional code other than a QR code, a three-dimensional code such as a PM code (registered trademark), an icon, an operation button of the terminal 120, a pop-up window, a text entry field, and/or a text display field. In addition, the object may have coordinate information. The coordinate information is information for specifying a position in the display region.

In the present embodiment, as the settlement executed with use of a two-dimensional code, the store scan type QR settlement will be described as an example in which a user who makes a payment displays a two-dimensional code 125 in the terminal 120 and a requesting user (or a store) scans the two-dimensional code 125, whereby the settlement is executed. The present embodiment is adapted to the user scan type QR settlement in which a requesting user (or a store) displays a two-dimensional code 125 in the terminal 120 and a user who makes the payment scans the two-dimensional code 125, whereby the settlement is executed. Note that the present embodiment is applicable to a terminal having a display screen which may be broken, in which a predetermined object is to be displayed.

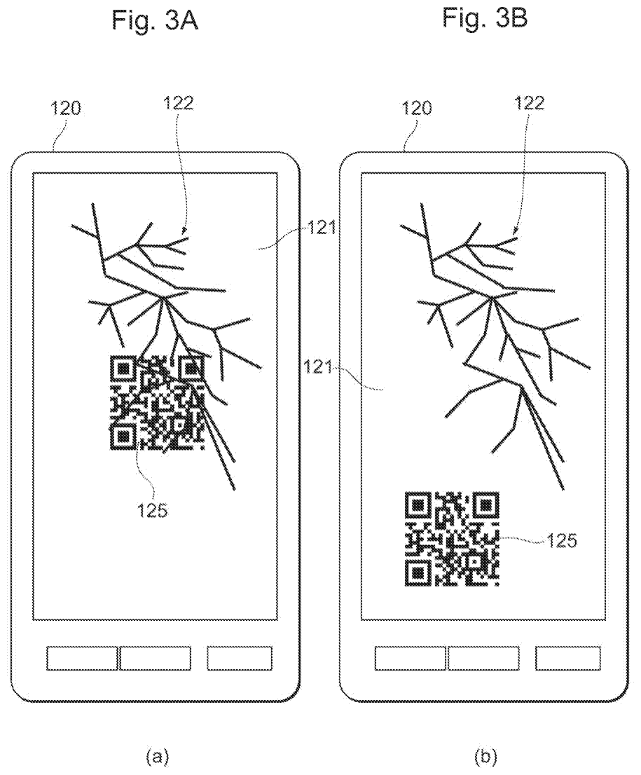

FIGS. 3A and 3B are diagrams illustrating an overview of a method of displaying a two-dimensional code according to the first embodiment. FIGS. 3A and 3B illustrate how the two-dimensional code 125 is displayed in a display region 121 of a display device provided in the terminal 120 when cracks 122 are formed in a part of the display device. The display device may be, for example, a liquid crystal display device including a touch panel.

FIG. 3A illustrates an example in which the two-dimensional code 125 is displayed by a conventional display method. In the conventional display method, the two-dimensional code 125 is displayed in a predetermined position in the display region 121, such as a center of the display region 121, for example. However, in the conventional display method, the two-dimensional code 125 is displayed in the predetermined position. Accordingly, in the case where the cracks 122 are formed in the screen, the two-dimensional code 125 may be displayed in a region in which cracks 122 are formed, which may cause a code scan error. Therefore, it is also possible that the displayed two-dimensional code 125 is moved by a dragging operation or the like, but the dragging operation or the like may be performed on the region including the cracks 122, and thereby it cannot be said that it is safe for the user.

On the other hand, FIG. 3B illustrates an example in which the two-dimensional code 125 is displayed in the display region 121 by a display method according to the present embodiment. In the display method according to the present embodiment, after a region (first region) in the display region 121 in which the two-dimensional code 125 is to be displayed is specified based on a user operation, the two-dimensional code 125 may be displayed in the first region. In addition, after a region (second region) in the display region 121 in which display of the two-dimensional code 125 is prohibited is specified based on a user operation, the two-dimensional code 125 may be also displayed in a region other than the second region.

For example, in the terminal 120, a region in the display region 121 where it is determined that cracks 122 or the like are not formed is specified as the first region based on a user operation, so that the two-dimensional code 125 can be displayed in the first region in which the cracks 122 or the like are not formed, as illustrated in FIG. 3B. In addition is the terminal 120, a region in the display region 121 where it is determined that cracks 122 or the like are formed is specified as the second region based on a user operation, so that the two-dimensional code 125 can be displayed in a region other than the second region, that is, a region where it is determined the cracks 122 or the like are not formed. Here, the phrase “based on a user operation” includes an explicit operation and an implicit operation by a user. The explicit operation includes the button press and the voice recognition for specifying the first region or the second region. Furthermore, the explicit operation may also include a user's operation of specifying the first region or the second region by using the button press or the voice recognition as a trigger. The implicit operation includes an operation when dropping of the terminal 120 or an impact on the terminal 120 is detected, and an operation based on the user's operation record with respect to the display region 121.

In this way, even when the cracks 122 or the like are formed in the display device of the terminal 120, a region where it is determined that the cracks 122 or the like are not formed is specified based on a user operation, so that the two-dimensional code 125 can be displayed in such a region. Therefore, code scan errors caused by the cracks 122 or the like can be reduced.

### Configuration of First Embodiment

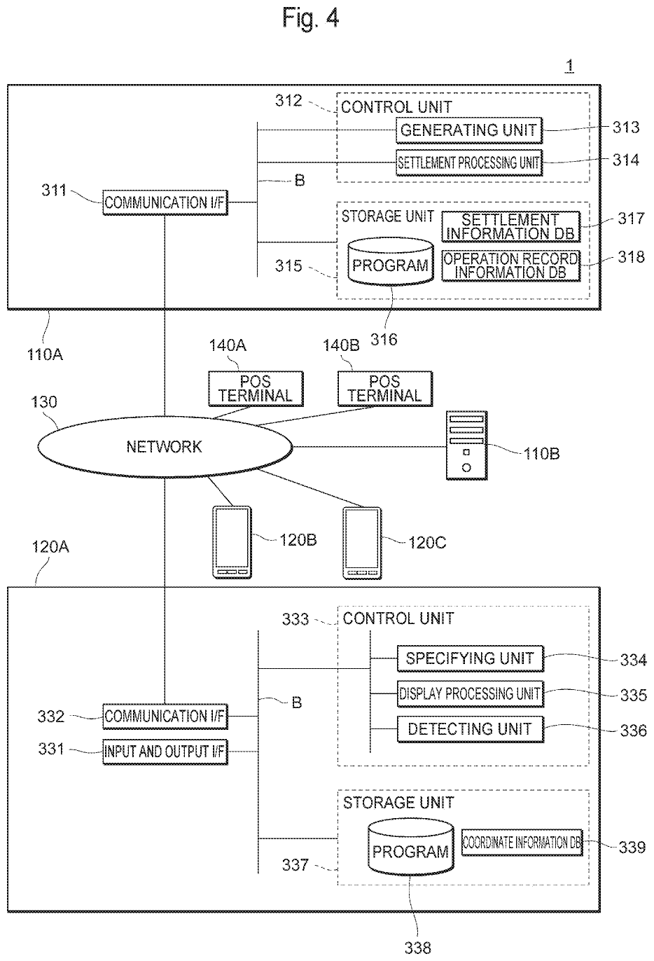

A configuration of the server 110 and/or the terminal 120 will be described with reference to FIG. 4.

Each unit disclosed in FIGS. 3A and 3B is embodied in cooperation with the processor 201, the memory 202, the storage 203, the input and output I/F 204, and the communication I/F 205 which are included in the information processing device 200. FIG. 4 is a block diagram illustrating a configuration of the communication system 1 for performing the settlement process with use of the two-dimensional code 125. The communication system 1 includes the server 110A, the server 110B, the terminal 120A, the terminal 120B, the terminal 120C, and the POS terminal 140A, and the POS terminal 140B.

### (1) Configuration of Server

The server 110 includes a communication I/F 311, a control unit 312, and a storage unit 315.

The communication I/F 311 transmits and receives the information to and from the terminal 120 and the POS terminal 140 through the network 130. Note that the communication I/F 311 corresponds to the above-described communication I/F 205 of FIG. 2.

The control unit 312 includes a generating unit 313 and a settlement processing unit 314. The generating unit 313 generates the code information. Here, the code information is information for displaying the two-dimensional code 125 used for the settlement process in the display region 121 of the terminal 120. The two-dimensional code 125 is displayed by encoding the code information. The code information is generated for each settlement. The generated code information is stored in a settlement information database (DB) 317 in the storage unit 315 in a state in which the code information is uniquely associated with the settlement information. Here, the settlement information is information used for the settlement process such as an amount of payment, and an identifier for identifying the user who makes the payment.

The settlement processing unit 314 performs various processing for executing the settlement. More specifically, the settlement processing unit 314 receives the code information which is received by the communication I/F 311 from the BPS terminal 140. Then, the settlement processing unit 314 acquires the settlement information associated with the code information from the settlement information DB 317 of the storage unit 315, and executes the settlement process based on the acquired settlement information.

The storage unit 315 stores the settlement information DB 317 and an operation record information DB 318 in addition to programs to be executed by the server 110.

In the settlement information DB 317, the settlement information is managed for each settlement. For example, the settlement information includes an amount of payment and an identifier for identifying a user who makes the payment. In addition, the settlement information DB 317 stores each piece of the settlement information with being uniquely associated with the corresponding code information generated by the generating unit 313 of the server 110.

In the operation record information DB 318, the operation record information which is information on the user's operation of the terminal 120 is managed. For example, the operation record information may include, for example but not limited to, the number of taps and swipes performed by the user on the display region 121 of the terminal 120, and the coordinate information of positions where the taps and the swipes are performed.

### (2) Configuration of Terminal

The terminal 120 includes an input and output I/F 331, a communication I/F 332, a control unit 333, and a storage unit 337.

The input and output I/F 331 receives input of the information or outputs the information. For example, the input and output I/F 331 receives input of the settlement information from a user who makes a payment. In addition, the input and output I/F 331 displays the two-dimensional code 125 for the POS terminal 140 to scan. The input and output I/F 331 corresponds to the input and output I/F 204 of FIG. 2.

The communication I/F 332 transmits and receives the information to and from the server 110 and the POS terminal 140 through the network 130. The communication I/F 332 corresponds to the communication I/F 205 of FIG. 2.

The control unit 333 includes a specifying unit 334, a display processing unit 335, and a detecting unit 336. The specifying unit 334 specifies the first region in which the two-dimensional code 125 is to be displayed, the first region being included in the display region 121 of the terminal 120, based on a user operation. Instead of specifying the first region or in parallel with specifying the first region, the specifying unit 334 may specify the second region in which display of the two-dimensional code 125 is prohibited, the second region being included in the display region 121 of the terminal 120, based on a user operation. The coordinate information of the first region and/or the second region specified by the specifying unit 334 is stored in a coordinate information DB 339 of the storage unit 337.

The display processing unit 335 displays the two-dimensional code 125 in the display region 121 of the terminal 120 based on the code information received by the communication I/F 332. At this time, the display processing unit 335 may acquire the coordinate information of the first region or the second region with reference to the coordinate information DB 339, and may display the two-dimensional code 125 in the first region or a region other than the second region. The display processing unit 335 displays the two-dimensional code 125 by encoding the code information.

The detecting unit 336 detects dropping of the terminal 120 and an impact on the terminal 120 from outside. The terminal 120 includes various sensors such as an acceleration sensor and a shock sensor (not illustrated), and therefore the detecting unit 336 may detect dropping of the terminal 120 and an impact on the terminal 120 based on the measurement results of these sensors. In addition, the detecting unit 336 may estimate that the display region 121 is broken when the shock sensor detects that an impact having a predetermined value or more is applied.

The coordinate information DB 339 manages the coordinate information of the first region and/or the second region specified by the specifying unit 334. In addition, the coordinate information DB 339 may also manage the coordinate information of the two-dimensional code 125 displayed in the display region 121.

### Display Process of Two-dimensional Code of First Embodiment

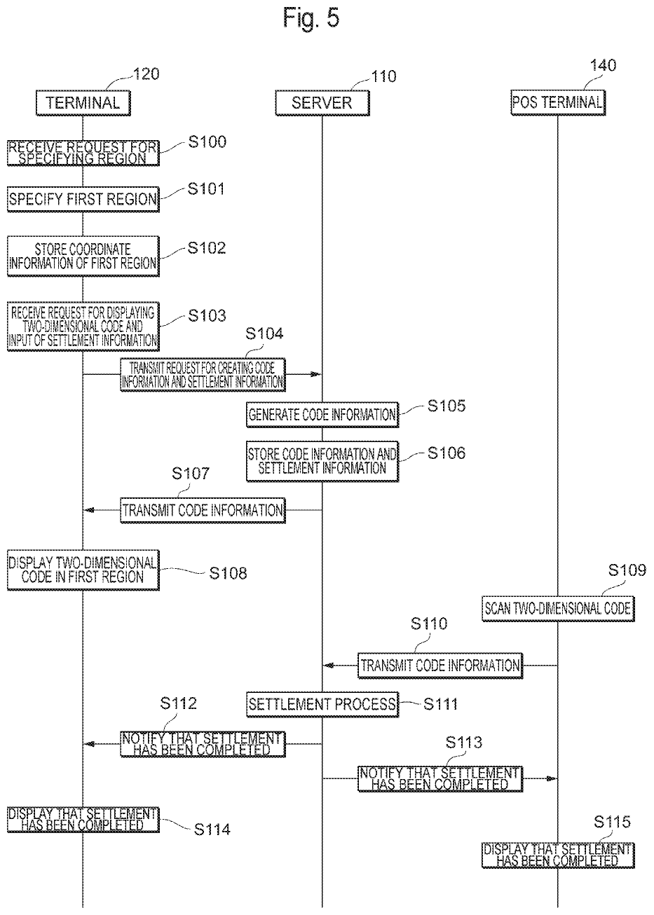

A display process of the two-dimensional code 125 which is performed by the communication system 1 according to the first embodiment will be described with reference to FIG. 5. FIG. 5 illustrates an example of a sequence of processing of the communication system 1 according to the first embodiment. Note that although the case where the first region in which the two-dimensional code 125 is to be displayed is specified will be described here, the similar processing sequence can be also applied to the case where the second region in which display of the two-dimensional code 125 is prohibited is specified.

Firstly, the input and output I/F 331 of the terminal 120 receives a request. for starting the specification of the first region in which the two-dimensional code 125 is to be displayed (step S100). For example, the input and output I/F 331 receives, from a user, the press of a button for starting the region specification, the button being displayed on the terminal 120.

Next, the specifying unit 334 of the terminal 120 specifies the first region based on a user operation (step S101), and acquires the coordinate information of the first region. Note that the specifying unit 334 may also specify a region other than the specified first region as the second region.

The specifying unit 334 causes the coordinate information DB 339 of the storage unit 337 to store the coordinate information of the specified first region (step S103).

Then, the input and output I/F 331 of the terminal 120 receives, from the user, the request for displaying the two-dimensional code 125 and the settlement information which is necessary for the settlement, such as an amount of payment and an identifier of the user who makes the payment (step S103). For example, in the application that performs the settlement with use of the two-dimensional code, the input and output I/F 331 receives, from the user, the press of the button for displaying the two-dimensional code 125 used for the settlement and the input of the settlement information.

The communication I/F 332 of the terminal 120 transmits a request for generating the code information and the settlement information input by the user to the server 110 (step S104).

When the communication I/F 311 of the server 110 receives the request for generating the code information, the generating unit 313 of the server 110 generates the code information for displaying the two-dimensional code 125 used for the settlement (step S105).

The settlement information received by the communication I/F 311 is stored in the settlement information DB 317 in association with the code information generated by the generating unit 313 (step S106).

The communication I/F 311 of the server 110 transmits the code information generated by the generating unit 313 to the terminal 120 (step 107).

The display processing unit 335 of the terminal 120 displays the two-dimensional code 125 in the first region based on the code information received by the communication I/F 332 (step S108). More specifically, as illustrated in FIGS. 3A and 3B, the two-dimensional code 125 is displayed by encoding the code information. At this time, the display processing unit 335 acquires the coordinate information of the first region with reference to the coordinate information DB 339 in the storage unit 337, and displays the two-dimensional code 125 in the first region.

The displayed two-dimensional code 125 may be changed in a display position, a display size, a display inclination (inclination with respect to a reference line on the screen (for example, a line parallel to a longitudinal direction of the screen)) according to a user operation. For example, when the display region 121 is a touch panel, the display position, display size and display inclination of the two-dimensional code 125 may be adjusted according to the user operation such as a swipe operation, a pinch-in operation, and a pinch-out operation on the screen.

The POS terminal 140 scans the two-dimensional code 125 displayed in the display region of the terminal 120 (step S109). The POS terminal 140 decodes the scanned two-dimensional code 125 to thereby convert it into the code information. The POS terminal 140 transmits the code information to the server 110 (step S110).

When receiving the code information from the POS terminal 140, the server 110 acquires the settlement information associated with the received code information with reference to the settlement information DB 317 (step S111).

After the settlement process is completed, the server 110 notifies the terminal 120 that the settlement has been completed (step S112). In addition, the server 110 also notifies the POS terminal 140 that the settlement has been completed (step S113).

After receiving, from the server 110, the notification that the settlement has been completed, the terminal 120 displays, in the display region 121, that the settlement has been completed (step S114). After receiving the notification that the settlement has been completed, the POS terminal 140 displays that the settlement has been completed (step S115). In this way, the process of the communication system 1 ends.

Note that, although the specifying process of specifying the first region which is performed by the specifying unit 334 (step S101) is performed before the terminal 120 receives the request for displaying the two-dimensional code 125 used for the settlement (before step S103) in the present embodiment, the timing for the specifying process is not limited. The timing for the specifying process may be, for example but not limited to, after the request for displaying the two-dimensional code 125 is received (after step S103), and after the code information of the two-dimensional code 125 used for the settlement is received from the server 110 (after step S107). In addition, after the display processing unit 335 displays the two-dimensional code 125 used for the settlement in a predetermined position in the display region 121 (for example, at a substantially center of the display region 121), the specifying unit 334 may perform a specifying process, so that the display processing unit 335 redisplays the two-dimensional code 125 in the first region specified by the specifying process again.

Furthermore, although in the present embodiment, the specifying process of specifying the first region which is performed by the specifying unit 334 is started by setting an even in which the input and output I/F 331 receives the request for specifying the region from the user (step S100) as a trigger, the specifying process may be started by setting an event in which the detecting unit 336 detects dropping of the terminal 120 or an impact on the terminal 120 as a trigger. More specifically, when the detecting unit 336 estimates that the display region is broken when the detecting unit 336 detects that an impact having a predetermined value or more is applied, the specifying unit 334 may start the specifying process. At this time, before the specifying unit 334 starts the specifying process, the display processing unit 335 may display, in the display region 121, a confirmation screen for confirming whether or not the specifying process is started, and receive an instruction as to whether or not the specifying process is started, from the user.

### First Example

A first example is an example in which the specifying unit 334 of the terminal 120 specifies the first region based on a user operation for specifying an unbroken region in the display region of the terminal 120.

According to the display method according to the first example, the specifying unit 334 specifies the unbroken region as the first region based on a user operation, whereby the two-dimensional code 125 is displayed in the unbroken region in the display region 121. That is, the two-dimensional code 125 is not displayed in the broken region, thereby improving the visibility of the two-dimensional code 125. For example, in the store scan type QR settlement, it is assumed that the two-dimensional code 125 is displayed in the terminal 120 in which the cracks 122 are formed in a part of the display region 121, and the displayed two-dimensional code 125 is scanned by the code reader of the POS terminal 140. At this time, the two-dimensional code 125 is appropriately displayed in a region (unbroken region) in which the cracks 122 are not formed. That is, the possibility for the contents of the two-dimensional code 125 to be erroneously scanned can be reduced, and the settlement process success rate can be improved.

When the user operation for specifying a region is an operation for specifying an unbroken region, the user can specify the region safely without touching the broken region.

### Configuration of First Example

### (1) Configuration of Terminal

The specifying unit 334 specifies the first region based on a user operation of specifying an unbroken region in the display region 121 of the terminal 120. For example, when the unbroken region in the display region 121 is specified by the user, the specifying unit 334 may specify the specified region as the first region.

Note that the user operation is not limited to specification of the unbroken region, and may be specification of the broken region. At this time, the specifying unit 334 may specify the specified broken region as the second region. Also, the user operation may be an operation for specifying both of the unbroken region and the broken region.

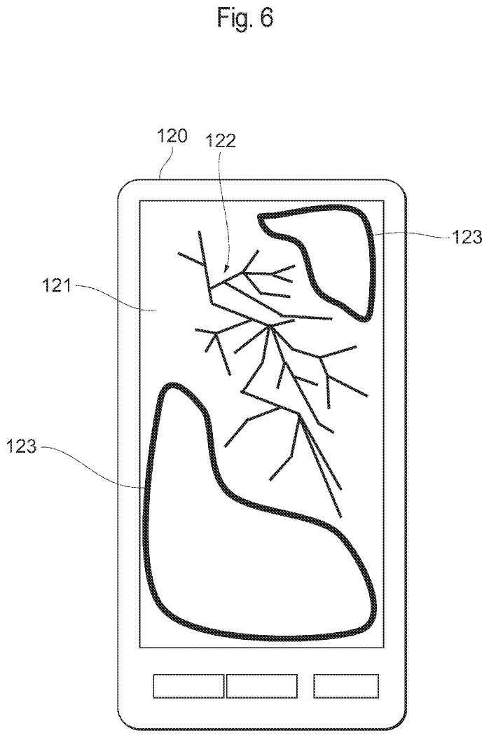

The display processing unit 335 displays a region specification screen in the display region 121. The region specification screen is a screen to be used by the user to specify the region. For example, when the display region 121 is a touch panel, the region specification screen may be displayed in a display form in which the fact that the user has specified the region can be confirmed visually, and as illustrated in FIG. 6, the region specification screen may be a screen in which a trace traced by a user's finger or a stylus is indicated by a solid line.

FIG. 6 illustrates an example of the region specification screen according to the first embodiment. FIG. 6 illustrates how a user specifies an unbroken region 123 of the display region 121 in the region specification screen. As illustrated in FIG. 6, the user may specify the unbroken region 123 by tracing around the outer edge of the unbroken region 123 using a finger or a stylus while the user avoids a region in which the cracks 122 are formed, as the broken region. In this example, two left-lower and right-upper regions in the display region 121 are specified as the unbroken regions as illustrated in FIG. 6. Note that the number of regions to be specified is not limited two, and may be one or three or more.

### Region Specifying Process of First Example

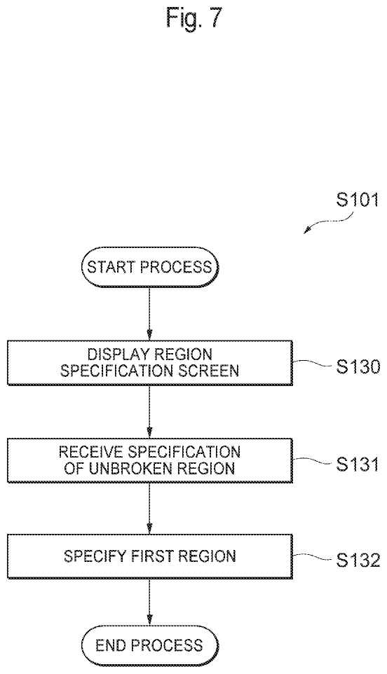

A process of specifying the first region which is performed by the terminal 120 will be described with reference to FIG. 7. FIG. 7 is a flowchart illustrating an example of a process of specifying the first region which is performed by the terminal 120 according to the first example of the first embodiment. The specifying process illustrated in FIG. 7 is an example of a process performed in the region specifying step (step S101) illustrated in FIG. 5. Note that although the case where the specifying unit 334 specifies the first region in which the two-dimensional code 125 is to be displayed based on the user operation of specifying the unbroken region 123 will be described here, the specifying unit 334 may specify the second region in which display of the two-dimensional code 125 is prohibited, based on the user operation of specifying the broken region.

Firstly, the display processing unit 335 of the terminal 120 displays the region specification screen for receiving user's specification of region in the display region 121 (step S130).

Next, the input and output I/F 331 of the terminal 120 receives the specification. of the unbroken region from. the user (step S131). For example, as illustrated in FIG. 6, the two left-lower and right-upper regions in the display region 121 may be specified as unbroken regions.

Then, the specifying unit 334 of the terminal 120 specifies the first region (step S132). For example, the specifying unit 334 specifies the unbroken region 123 specified by the user as the first region. Note that the specifying unit 334 may specify a region other than the specified first region, as the second region. In this way, the specifying process performed by the terminal 120 ends.

### Second Example

A second example is an example in which the specifying unit 334 specifies the first region based on the user's specifications of the display position, display size and display inclination of the two-dimensional code 125, after the display processing unit 335 of the terminal 120 displays the two-dimensional code 125 in the display region 121. More specifically, the specifying unit 334 specifies the region in which the two-dimensional code 125 is displayed, as the first region, when the user's specifications of the display position, display size and the display inclination of the two-dimensional code 125 are completed.

According to the display method according to the second example, the region is specified by the user with use of the two-dimensional code 125 displayed in the display region 121. That is, the user can specify intuitively the region in which the two-dimensional code 125 is to be displayed while confirming the actual display form of the two-dimensional code 125.

### Configuration of Second Example

### (1) Configuration of Terminal

The specifying unit 334 specifies the first region based on the content of user's specification of at least one of user's specification of the display position, user's specification of the display size, and user's specification of the display inclination of the two-dimensional code 125. For example, it is assumed that the user specifies the display position, display size and display inclination of the two-dimensional code 125 after the display processing unit 335 displays, in the display region 121, the two-dimensional code 125 for specifying the display position, display size and display inclination of the two-dimensional code 125. At this time, the specifying unit 334 specifies a region in which the two-dimensional code 125 is present, as the first region, when the user's specifications are completed. Note that the specifying unit 334 may specify a region in which the two-dimensional code 125 is not displayed, as the second region.

The display processing unit 335 displays, in the display region 121, the two-dimensional code 125 whose position and size can be specified by the user.

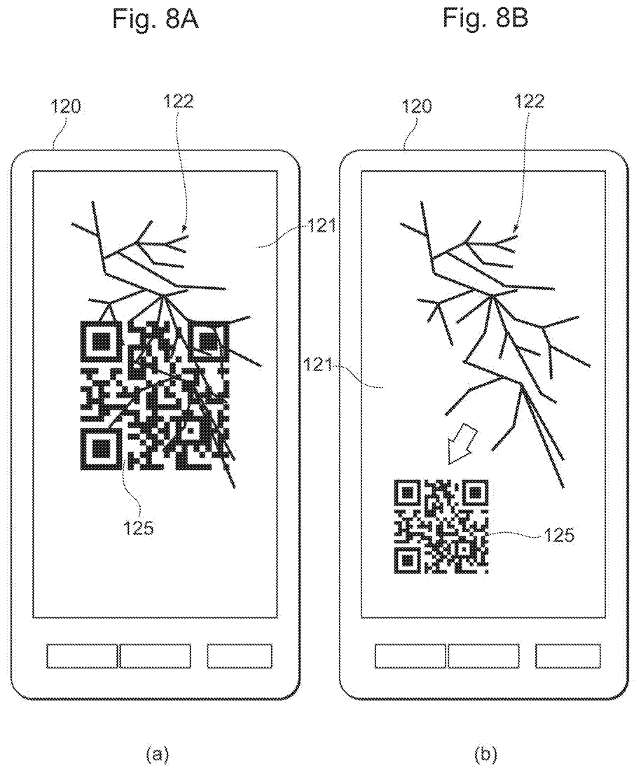

FIGS. 8A and 8B illustrate an example of a process of specifying a display position and a display size of the two-dimensional code 125 by a user. As illustrated in FIG. 8A, firstly, the two-dimensional code 125 for specifying the region is displayed in the display region 121 of the terminal 120. In this example, as illustrated in FIGS. 8A and 8B, the two-dimensional code 125 is displayed in a preset, size at a substantially center of the display region. The two-dimensional code 125 is displayed in a region in the display region 121 in which the cracks 122 are formed. Then, the position and size of the two-dimensional code 125 are specified by the user operation. In this example, after the user's specifications are completed, the two-dimensional code 125 is moved to the left-lower region in the display region 121 by the user operation, and is displayed in a smaller size than before the user specifies the size. Therefore, as illustrated in FIG. 8B, the two-dimensional code 125 is not displayed. in a region in which the cracks 122 are formed. Note that the lower limit of the display size of the two-dimensional code 125 may be set in a size so that the two-dimensional code 125 can be scanned by the code reader provided in the POS terminal 140. Note that although in this example, the case is described where the display position and display size of the two-dimensional code 125 are specified by the user, a process of specifying the display inclination of the two-dimensional code 125 may be performed by performing an operation of rotating the two-dimensional code 125, or the like.

### Region Specifying Process of Second Example

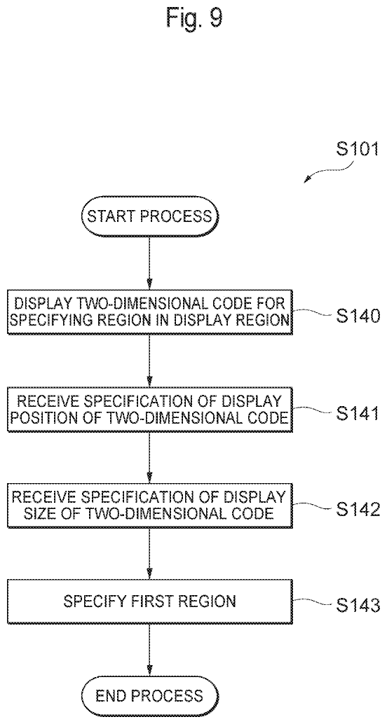

A process of specifying the first region which is performed by the terminal 120 will be described with reference to FIG. 9. FIG. 9 is a flowchart illustrating an example of a process of specifying the first region which is performed by the terminal 120 according to the second example of the first embodiment. Note that although the case where a region in which the two-dimensional code 125 is displayed is specified as the first region after the display position and display size of the two-dimensional code 125 is specified by the user will be described here, a region in which the two-dimensional code 125 is not displayed may be specified as the second region. The specifying process illustrated in

FIG. 9 may be an example of a process performed by the region specifying step (step S101) illustrated in FIG. 5.

Firstly, the display processing unit 335 of the terminal 120 displays the two-dimensional code 125 for specifying the region in the display region 121 (step S140). For example, as illustrated in FIGS. 8A and 8B, the two-dimensional code 125 may be displayed in a preset size at a substantially center of the display region 121.

Next, the input and output I/F 331 of the terminal 120 receives the specification of the display position of the two-dimensional code code 125 from the user (step S141). When the display region 121 is a touch panel, the display position of the two-dimensional code 125 may be specified by moving the two-dimensional code 125 in response to a user operation such as swipe.

Furthermore, the input and output I/F 331 of the terminal 120 receives the specification of the display size of the two-dimensional code 125 from the user (step S142). When the display region 121 is a touch panel, the display size of the two-dimensional code 125 may be specified by changing the size of the two-dimensional code 125 in response to a user operation such as a pinch-in operation and a pinch-out operation.

In addition, the input and output I/F 331 of the terminal 120 may receive the specification of the inclination of the two-dimensional code 125 from the user (not illustrated). When the display region 121 is a touch panel, the inclination of the two-dimensional code 125 may be specified by changing the inclination of the two-dimensional code 125 in response to a user operation of rotating the two-dimensional code 125, or the like.

Then, the specifying unit 334 of the terminal 120 specifies the first region (step S143). More specifically, the specifying unit 334 specifies a region in which the two-dimensional code 125 is present, as the first region. Note that the specifying unit 334 may specify a region in which the two-dimensional code 125 is not displayed, as the second region. In this way, the specifying process performed by the terminal 120 ends.

Note that although in this example, a step of receiving the specification of the display size (step S142) is executed after a step of receiving the specification of the display position of the two-dimensional code 125 (step S141) is executed, the order in which the two steps are executed and the number of times the two steps are executed are not limited.

Note that, in this example, the specifying unit 334 executes a process of specifying the first region with use of the two-dimensional code 125 for specifying a region. However, the specifying unit 334 may execute a specifying process with use of the two-dimensional code 125 used for the actual settlement process. More specifically, after the display processing unit 335 displays the two-dimensional code 125 used for the settlement, the user may specify the display position, display size and display inclination of the two-dimensional code 125, and the specifying unit 334 may specify the first region based on the specified display position, display size and display inclination of the two-dimensional code 125.

At this time, the display processing unit 335 may update the shape of the two-dimensional code 125 to a different shape in response to changes of the two-dimensional code 125 in display position, display size, and display inclination. More specifically, when the display position and the like of the two-dimensional code 125 is changed, the information indicating that the display position and the like of the two-dimensional code 125 has been changed is transmitted to the server 110. Then, the generating unit 313 of the server 110 updates the code information tied to the settlement information managed in the storage unit 315 to new code information, and the communication I/F 311 of the server 110 transmits the new code information to the terminal 120. The communication I/F 311 of the terminal 120 receives the new code information, and the display processing unit 335 encodes the new code information to display the two-dimensional code 125 having a different shape. Thus, updating the shape of the two-dimensional code 125 can reduce the likelihood of abuse when the two-dimensional code 125 leaks to a third party.

### Third Example

A third example is an example in which after the display processing unit 335 of the terminal 120 displays a plurality of two-dimensional codes 125 in the display region 121, the specifying unit 334 specifies a region in which the two-dimensional code(s) 125 which is/are correctly recognizable is/are displayed, as the first region. For example, after the display processing unit 335 displays the plurality of two-dimensional codes 125 in the display region 121, the code reader scans the two-dimensional code 125. The specifying unit 334 may specify a region in which the two-dimensional code(s) 125 correctly scanned by the code reader is/are present, as the first region. In addition, the specifying unit 334 may specify, as the second region, a region in which among the plurality of two-dimensional codes 125 displayed in the display region 121, the two-dimensional code(s) 125 which is/are not recognizable in the first place or is not correctly recognizable is/are displayed. For example, in the above-described examples, the specifying unit 334 may specify, as the second region, a region the two-dimensional code(s) 125 which cannot be scanned or cannot be correctly scanned by the code reader is/are present.

According to the display method according to the third example, the terminal 120 can specify automatically a region(s) in the display region 121 in which the two-dimensional code(s) 125 is/are appropriately displayed. That is, the user does not need to move the two-dimensional code 125 in the display region 121 to specify the region in which the two-dimensional code 125 is appropriately displayed, whereby the operation load of the user can be reduced.

### Configuration of Third Example

### (1) Configuration of Terminal

The specifying unit 334 specifies the first region based on the information as to whether or not each of the plurality of two-dimensional codes 125 displayed in the display region 121 is correctly recognized. For example, the specifying unit 334 specifies, as the first region, a region in which among the plurality of two-dimensional codes 125 displayed in the display region 121, the two-dimensional code(s) 125 correctly scanned by the code reader is/are present.

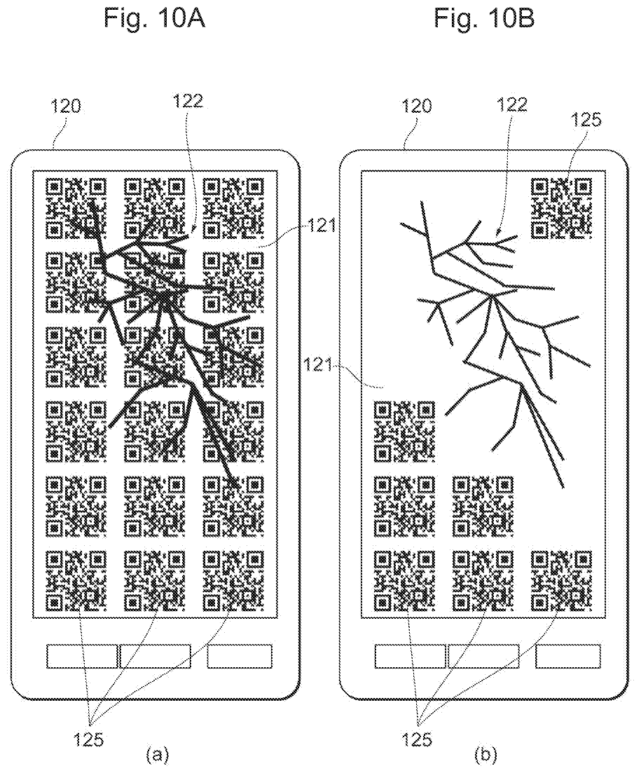

FIGS. 10A and 10B illustrate a process of specifying the first region with use of the plurality of two-dimensional codes 125 displayed in the display region 121. As illustrated in FIG. 10A, firstly, the plurality of two-dimensional codes 125 are displayed in the display region 121 of the terminal 120. In this example, as illustrated in FIG. 10A, the plurality of two-dimensional codes 125 are displayed in the substantially entire region of the display region 121. Then, the code reader scans the two-dimensional code(s) 125, and the specifying unit 334 specifies the first region based on a scanning result. More specifically, as described above, a region in which the two-dimensional code(s) 125 correctly scanned by the code reader is/are present is specified as the first region.

FIG. 10B illustrates the display region 121 in which only two-dimensional codes 125 correctly scanned are displayed. For example, as illustrated in FIG. 10B, the two-dimensional codes 125 displayed in a region in which the cracks 122 are not formed can be correctly scanned.

### Region Specifying Process of Third Example

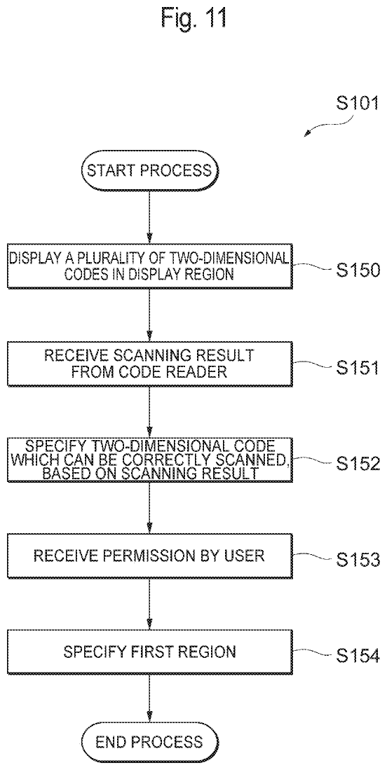

A process of specifying the first region which is performed by the terminal 120 will be described with reference to FIG. 11. FIG. 11 is a flowchart illustrating an example of a process of specifying the first region which is performed by the terminal 120 according to the third example of the first embodiment. Note that although the case where the specifying unit 334 specifies, as the first region, a region in the display region 121 in which the two-dimensional code(s) 125 correctly scanned by the code reader is/are present will be described here, a region in which the two-dimensional code(s) 125 which cannot be scanned or cannot be correctly scanned is/are present may be specified as the second region. The specifying process illustrated in FIG. 11 is an example of a process performed in the region specifying step (step S101) illustrated in FIG. 5.

Firstly, the display processing unit 335 of the terminal 120 displays the plurality of two-dimensional codes 125 in the display region 121 (step S150). For example, as illustrated in FIG. 10A, the plurality of two-dimensional codes 125 may be displayed in the substantially entire region of the display region 121.

Next, the two-dimensional code(s) 125 is/are scanned by the code reader, and the communication I/F 332 of the terminal 120 receives a scanning result of the two-dimensional code(s) 125 from the code reader (step S151). At this time, the communication I/F 332 may receive the scanning result received from the code reader via the server 110.

The specifying unit 334 of the terminal 120 specifies the two-dimensional code(s) 125 whose contents are correctly scanned, among the plurality of two-dimensional codes 125, based on the scanning result (step S152).

Then, the display processing unit 335 may display, in the display region 121, only the two-dimensional code(s) 125 which are accurately scanned, and ask the user for permission whether a region in which the two-dimensional code(s) 125 is/are present may be specified as the first region. At this time, as illustrated in FIG. 10B, the display processing unit 335 may display, in the display region 121, only the two-dimensional code(s) 125 whose contents are correctly scanned.

After the display processing unit 335 receives user's permission (step S153), the specifying unit 334 of the terminal 120 specifies, as the first region, a region in which the two-dimensional code(s) 125 whose contents are correctly scanned (step S154). Note that the specifying unit 334 may specify, as the second region, a region other than the region in the display region 121 in which the two-dimensional code (s) 125 correctly scanned by the code reader is/are present. In this way, the specifying process performed by the terminal 120 ends.

### Fourth Example

A fourth example is an example in which the first region and/or the second region is specified based on the operation record information of the terminal 120 of the user.

According to the display method according to the fourth example, the specifying unit 334 specifies at least one of the first region and the second region automatically, based on the operation record information of the user terminal, without the user specifying the region in the display region 121. Therefore, the operation load for user's specification of the region can be reduced. In addition, the specifying unit 334 can estimate that the display region is broken and where the broken region is, based on the user's operation record information in a predetermined period, and the display processing unit 335 can display the two-dimensional code(s) 125 at an appropriate positon(s) while avoiding the broken region.

### Configuration of Fourth Example

### (1) Configuration of Terminal

The specifying unit 334 specifies at least one of the first region and the second region based on the operation record information of the terminal 120 of the user. For example, after estimating that the display region 121 is broken and where the broken region is, by analyzing the user's operation record information in a predetermined period, the specifying unit 334 may specify, as the second region, a region estimated as the broken region. In the case where the display region 121 is a touch panel, when the cracks 122 are formed in a part of the display region 121, the user tends to perform the operation while avoiding touch with the region in which the cracks 122 are formed. That is, the number of times the user touches the broken region from the point of time when breakage of the display region 121 occurs is reduced. The specifying unit 334 analyzes the operation record information in a predetermined period, and estimates that the display region 121 is broken by specifying a region in the display region 121 in which the number of times the user touches the broken region is reduced. In addition, the specifying unit 334 estimates, as the broken region, the region in which the number of times the user touches the broken region is reduced. Note that the specifying unit 334 may specify a region other than the region estimated as the broken region, as the first region.

### Region Specifying Process of Fourth Example

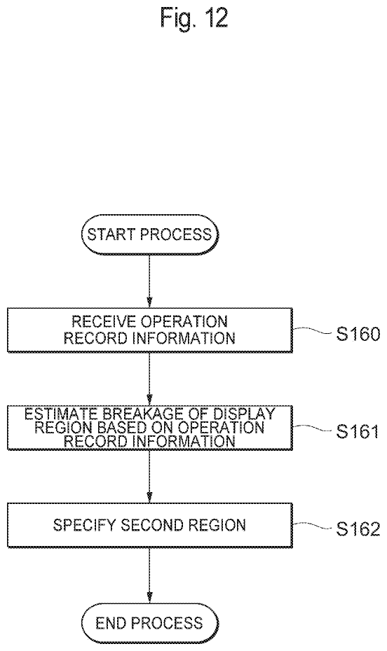

A process of specifying the second region which is performed by the terminal 120 will be described with reference to FIG. 12. FIG. 12 is a flowchart illustrating an example of a process of specifying the second region which is performed by the terminal 120 according to the fourth example of the first embodiment. Note that although, here, the specifying unit 334 specifies, as the second region, a region in the display region 121 in which the number of times the user touches the broken region is reduced, the specifying unit 334 may specify, as the first region, a region in which the number of times the user touches the broken region is not reduced. In this example, the case where the specifying unit 334 estimates the breakage of the display region 121 based on the user's operation record information in a predetermined period will be described.

Firstly, the communication I/F 332 of the terminal 120 receives, from the server 110, the operation record information of the terminal 120 of the user in a predetermined period (step S160). For example, the operation record information may include the number of times the user touches the display region 121 while the user is operating the terminal 120 and the coordinate information on regions touches by the user in the display region 121.

Next, the specifying unit 334 analyzes the operation record information and specifies a region in the display region 121 in which the number of touches of the user is reduced in a predetermined period.

When specifying a region in the display region 121 in which the number of touches of the user is reduced, the specifying unit 334 estimates that, the display region 121 is broken (step S161). In addition, the specifying unit 334 estimates the region in which the number of touches of the user is reduced, as the broken region.

Then, the specifying unit 334 specifies, as the second region, the region estimated as the broken region (step S162). At this time, the specifying unit 334 may specify, as the first region, a region other than the region estimated as the broken region. In this way, the specifying process performed by the terminal 120 ends.

In addition, when an object to be displayed in the display region 121 is an object such as an operation button and an icon of the terminal 120, the object being provided to execute the process by user's touch, the specifying unit 334 may specify a region based on the operation record information in the display region in which the number of touches of the user is large. At this time, the specifying unit 334 may specify, as the first region, the region in which the number of touches of the user is large. When operating the terminal 120, the user tends to mainly touch the region in the display region 121 in which the user is likely to perform the touch operation. Therefore, by displaying the operation button and the icon in the region in which the number of touches of the user is large, the operation button and the icon can be displayed at positions at which the user is likely to perform the touch operation.

### Fifth Example

A fifth example is an example in which when the terminal 120 receives a request for displaying a two-dimensional code 125 from the user, the display processing unit 335 displays a new two dimensional code based on coordinate information of two-dimensional code(s) 125 displayed in the past in the case where the storage unit 337 holds the coordinate information, and the display processing unit 335 displays the new two-dimensional code 125 after the specifying unit 334 performs a process of specifying the first region in the case where the storage unit 337 does not hold the coordinate information.

According to the display method according to the fifth example, when the storage unit 337 holds the coordinate information of two-dimensional codes 125 displayed in the past, the display processing unit 335 can display a two-dimensional code 125 at an appropriate position rapidly without the specifying unit 334 performing a process of specifying the region. That is, the operation load of the user and the processing load of the terminal 120 due to the process of specifying the region can be reduced.

### Configuration of Fifth Example

### (1) Configuration of Terminal

The display processing unit 335 acquires the coordinate information of the two-dimensional codes 125 displayed in the past from the storage unit 337, and displays the new two-dimensional code 125 is the display region 121 based on the acquired coordinate information. For example, the display processing unit 335 displays the new two-dimensional code 125 at the same position as the position at which another two-dimensional code 125 has been displayed in the past. The coordinate information of the two-dimensional code 125 displayed in the past is managed by the coordinate information DB 339 of the storage unit 337.

After the display processing unit 335 displays the new two-dimensional code 125, the storage unit 337 manages the coordinate information of this two-dimensional code 125 in the coordinate information DB 339.

### Display Process of Two-dimensional Code of Fifth Example

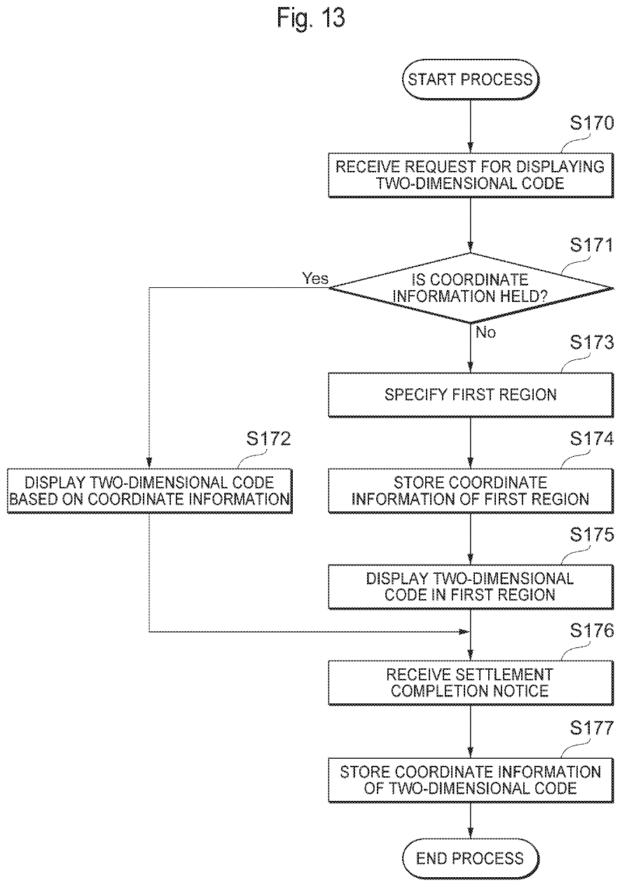

A display process of the two-dimensional code 125 which is performed by the terminal 120 will be described with reference to FIG. 13. FIG. 13 is a flowchart illustrating an example of a display process of the two-dimensional code 125 which is performed by the terminal 120 according to the fifth example of the first embodiment.

Firstly, the input and output I/F 331 of the terminal 120 receives a request for displaying the two-dimensional code 125 from the user (step S170). For example, is the application in which the user performs the settlement with use of the two-dimensional code 125, the input and output I/F 331 receives the press of the button for displaying the two-dimensional code 125.

When the input and output I/F 331 receives the display request from the user, the display processing unit 335 determines whether or not the storage unit 337 holds the coordinate information of the two-dimensional codes 125 displayed in the past with reference to the coordinate information DB 339 of the storage unit 337 (step S171).

When the storage unit 337 holds the coordinate information (Yes in step S171), the display processing unit 335 displays the two-dimensional code 125 based on the coordinate information (step S172). For example, the display processing unit 335 displays the new two-dimensional code 125 at the same position as the position at which the two-dimensional code 125 has been displayed in the past.

When the storage unit 337 does not hold the coordinate information (No in step S171), the specifying unit 334 executes a process of specifying the first region, and specifies the first region (step S173). Note that although the case where the first region in which the two-dimensional code 125 is to be displayed is specified will be described here, the second region in which display of the two-dimensional code 125 is prohibited may be specified.

The storage unit 337 stores the coordinate information of the specified first region in the coordinate information DB 339 (step S174).

The display processing unit 335 displays the two-dimensional code 125 in the first region specified by the specifying unit 334 (step S175).

The storage unit 337 stores the coordinate information of the displayed two-dimensional code 125 in the coordinate information DB 339 (step S176). The coordinate information may be stored in the storage unit 337 in response to a fact that the settlement has been completed. The fact that the settlement has been completed may be a fact that the terminal 120 has received the information that the settlement has been completed (settlement completion notice) from the server 110, or a fact that the screen displayed in the display region 121 is shifted from the screen in which the two-dimensional code 125 is displayed to another screen such as a screen indicating the settlement completion. In this way, the display process of the two-dimensional code 125 which is performed by the terminal 120 ends.

Note that it is not always necessary for the display processing unit 335 to perform a determination process as to whether or not the storage unit 337 holds the coordinate information (step S171). When the storage unit 337 holds the coordinate information, the display processing unit 335 may display the new two-dimensional code 125 based on the coordinate information held by the storage unit 337. When the storage unit 337 does not hold the coordinate information, the display processing unit 335 may display the two-dimensional code 125 after the specifying unit 334 executes a process of specifying the first region.

### Sixth Example

A sixth example is an example in which when the terminal 120 receives a request for displaying the two-dimensional code 125 from the user, the terminal 120 executes any one of a first mode in which the two-dimensional code 125 is displayed at a predetermined position in the display region 121, and a second mode in which the two-dimensional code 125 is displayed in the first region after the first region is specified.

According to the display method according to the sixth example, when the specifying unit 334 does not need to execute a process of specifying the region, the specifying unit 334 does not perform the specifying process, and executes the first mode in which the two-dimensional code 125 is displayed at a predetermined position, and the display processing unit 335 displays the two-dimensional code 125 rapidly.

### Display Process of Two-dimensional Code of Sixth Example

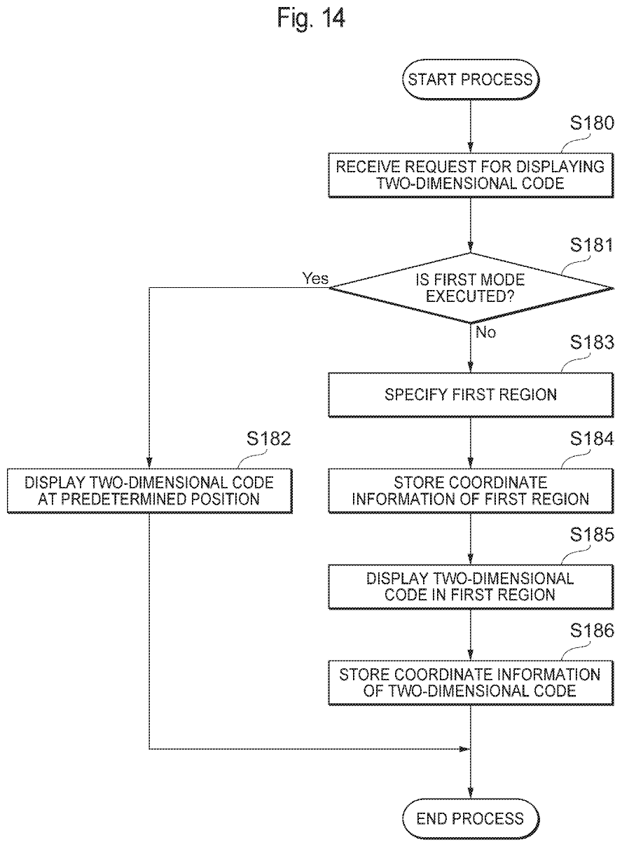

A display process of the two-dimensional code 125 which is performed by the terminal 120 will be described with reference to FIG. 14. FIG. 14 is a flowchart illustrating an example of a display process of the two-dimensional code 125 which is performed by the terminal 120 according to the sixth example of the first embodiment.

Firstly, the input and output I/F 331 of the terminal 120 receives a request for displaying the two-dimensional code 125 from the user (step S180). For example, in the application in which the user performs the settlement with use of the two-dimensional code 125, the input and output I/F 331 receives the press of the button for displaying the two-dimensional code 125.

Then, the display processing unit 335 determines whether or not the first mode is executed (step S181). At this time, the display processing unit 335 may receive an instruction as to whether or not the first mode is executed, from the user via the input and output I/F 332, and make the determination based on the instruction.

Furthermore, the display processing unit 335 may determine whether or not the first mode is executed based on the detection result of the detecting unit 336. More specifically, when the acceleration sensor and the shock sensor which are included in the terminal 120 measure an acceleration and impact each having a predetermined value or more, respectively, the detecting unit 336 estimates that the display region 121 of the terminal 120 has been broken by an impact due to dropping of the terminal 120. At this time, the display processing unit 335 may determine that the first mode in which the two-dimensional code 125 is displayed at a predetermined position in the display region 121 is not executed.

When the display processing unit 335 determines that the first mode is executed (Yes in step S181), the display processing unit 335 executes the first mode in which the two-dimensional code 125 is displayed at a predetermined position in the display region 121 (step S182).

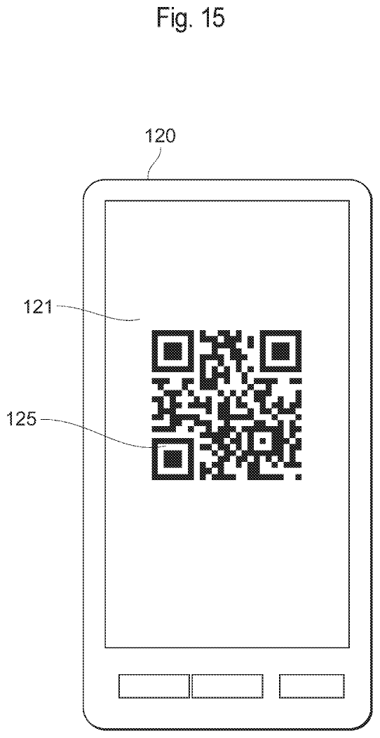

FIG. 15 is a diagram illustrating a state in which the two-dimensional code 125 is displayed in a predetermined position in the display region 121 by the display processing unit 335 when the first mode is executed. In this example, the two-dimensional code 125 is displayed at a substantially center of the display region 121.

When the display processing unit 335 does not determine that the first mode is executed (No in step S181), the display processing unit 335 executes the second mode in which the two-dimensional code 125 is displayed in the first region after the first region is specified. Note that although the case where the specifying unit 334 specifies the first region in which the two-dimensional code 125 is to be displayed will be described here, the second region in which display of the two-dimensional code 125 is prohibited may be specified.

Firstly, the specifying unit 334 executes a process of specifying the first region (step S183). Then, the storage unit 337 stores the coordinate information of the specified first region in the coordinate information DB 339 (step S184).

Then, the display processing unit 335 displays the two-dimensional code 125 in the first region (step S185).

The storage unit 337 stores the coordinate information of the displayed two-dimensional code 125 in the coordinate information DB 339 (step S186). In this way, the display process of the two-dimensional code which is performed by the terminal 120 ends.

The embodiments described above serve merely to facilitate understanding of the present invention, and are not to be interpreted as restricting the scope of the invention. The different elements included in the embodiments, and their arrangement, materials, conditions, shapes and sizes may be appropriately modified without any limitation to the examples shown. In addition, the configurations of different embodiments may also be partially replaced or combined with each other.

### CROSS REFERENCE TO RELATED APPLICATION

The present application is based on Japanese Patent Application No. 2018-170641 filed on Sep. 12, 2018, the contents of which are incorporated herein by reference.

### REFERENCE SIGNS LIST

1 Communication system
110 Server
120 Terminal
121 Display region
123 Unbroken region
125 Two-dimensional code
130 Network
140 POS terminal
200 Information processing device
201 Processor
202 Memory
203 Storage
204 Input and output I/F
205 Communication I/F
311 Communication I/F
312 Control unit
313 Generating unit
314 Settlement processing unit
315 Storage unit
317 Settlement information DB
318 Operation record information DB
331 Input and output I/F
332 Communication I/F
333 Control unit
334 Specifying unit
335 Display processing unit
336 Detecting unit
337 Storage unit
339 Coordinate information DB

What is claimed is:

1. An information processing method, executed by one or more processors included in an information processing device, comprising:
electronically specifying at least one of a first region in which an object is to be displayed and/or a second region in which display of the object is prohibited, the first region and the second region being included in a display region of a display device, based on a user operation; and
electronically displaying the object in the specified first region of the display device or displaying the object in a region other than the specified second region of the display device.

2. The information processing method according to claim 1, wherein
the user operation includes an operation of specifying an unbroken region or a broken region in the display region.

3. The information processing method according to claim 1, wherein
the specifying includes:
specifying the second region based on a result of specification of the first region; and
specifying the first region based on a result of specification of the second region.

4. The information processing method according to claim 1, wherein
the specifying includes displaying an image for specifying the first region in the display region.

5. The information processing method according to claim 1, wherein
the specifying includes specifying at least one of the first region and the second region based on user's operation record information.

6. The information processing method according to claim 1, wherein
the user operation includes an operation of specifying a display position of the object in the display region.

7. The information processing method according to claim wherein
the user operation includes an operation of specifying a display size of the object in the display region.

8. The information processing method according to claim 1, wherein
the user operation includes an operation of specifying a display inclination of the object in the display region.

9. The information processing method according to claim 1, wherein
the object includes a two-dimensional code.

10. The information processing method according to claim 9, wherein
the two-dimensional code is updated in response to an operation of specifying a display position of the object, or an operation of specifying a display size of the object, or an operation of specifying a display inclination of the object.

11. The information processing method according to claim 10, wherein
the two-dimensional code includes coordinate information in the display region.

12. The information processing method according to claim 11, further comprising:
electronically storing the coordinate information as information for specifying the first region in response to a fact that a settlement associated with the two-dimensional code has been completed.

13. The information processing method according to claim 12, wherein
it is determined that the settlement associated with the two-dimensional code has been completed in response to a fact that a screen displayed in the display device is changed from a screen in which the two-dimensional code is displayed to another screen.

14. The information processing method according to claim 13, wherein
it is determined that the settlement associated with the two-dimensional code has been completed based on a fact that information indicating that the settlement based on the two-dimensional code has been completed has been received from another information processing device.

15. The information processing method according to claim 12, further comprising:
displaying another two-dimensional code different from the two-dimensional code based on the stored coordinate information.

16. The information processing method according to claim 1, further comprising:
automatically estimating a breakage of the display region based on dropping of the information processing device or an impact on the information processing device.

17. The information processing method according to claim 16, wherein
the specifying is executed based on a fact that the breakage of the display region has been estimated.

18. The information processing method according to claim 1, wherein
any one of a first mode in which the object is displayed at a predetermined position in the display region, and a second mode in which the object is displayed in the first region or a region other than the second region after the specifying is executed.

19. A computer-readable non-transitory storage medium having a program stored thereon, the program causing one or more processors included in an information processing device to execute:
electronically specifying at least one of a first region in which an object is to be displayed and a second region in which display of the object is prohibited, the first region and the second region being included in a display region of a display device, based on a user operation; and
electronically displaying the object in the specified first region of the display device or displaying the object in a region other than the specified second region of the display device.

20. An information processing device comprising:
one or more processors,
wherein the one or more processors execute:
electronically specifying at least one of a first region in which an object is to be displayed and a second region in which display of the object is prohibited, the first region and the second region being included in a display region of a display device, based on a user operation; and
electronically displaying the object in the specified first region of the display device or displaying the object in a region other than the specified second region of the display device.
